(19) United States
(12) Patent Application Publication
(10) Pub. No.: US 2025/0382218 A1
(43) Pub. Date: Dec. 18, 2025

(54) LIGHT WEIGHT SUBSTRATE WITH GLASS BUBBLE SKELETON HAVING MIXED POROSITY FOR CARBON CAPTURE AND METHOD OF MAKING

(71) Applicant: CORNING INCORPORATED, CORNING, NY (US)

(72) Inventors: Weimin Hou, Shanghai (CN); Qing Zhou, Shanghai (CN)

(21) Appl. No.: 18/881,120

(22) PCT Filed: Jul. 11, 2023
(86) PCT No.: PCT/US2023/027340

§ 371 Date: Jan. 3, 2025

(30) Foreign Application Priority Data
Jul. 15, 2022 (CN) 202210837104.2

(51) Int. Cl. C03C 11/00; B01D 53/02; B01J 20/28; B01J 20/30; C03B 19/06

(52) U.S. Cl. CPC C03C 11/002; B01J 20/28011; B01J 20/28033; B01J 20/28083; B01J 20/28085; B01J 20/3007; B01J 20/3078; C03B 19/06; B01D 53/02; B01D 2253/25; B01D 2257/504

(57) ABSTRACT

A porous structure includes a plurality of glass bubbles that are sintered to one another such that adjoining glass bubbles are physically bonded directly to one another. The glass bubbles have surfaces that define interstices throughout the porous structure. The interstices include closed interstices that do not open to surfaces of the porous structure. At least 50% of the glass bubbles are closed glass bubbles with each closed glass bubble defining a sealed void therein. The porous structure has at least 10% closed porosity and at least 40% open porosity. The closed porosity includes the sealed voids and the closed interstices. A method for making the porous structure includes heating the glass bubbles. Prior to the heating, substantially all of the glass bubbles are closed glass bubbles. At least 50% of the glass bubbles remain closed after the heating such that the sintered, closed glass bubbles form the porous structure.

### CROSS-REFERENCE TO RELATED APPLICATIONS

This application claims the benefit of priority under 35 U.S.C. § 119 of Chinese Patent Application No. 202210837104.2, filed Jul. 15, 2022, the content of which is relied upon and incorporated herein by reference in its entirety.

### FIELD

The present disclosure relates to porous inorganic structures and, more particularly, to porous structures with high proportions of fused, closed glass bubbles defining inorganic skeletons with mixed porosity.

### BACKGROUND

Fabrication of composite materials using small glass bubbles (also referred to as “hollow” and/or “glass” used optionally with any of “spheres,” “microspheres,” “beads,” or “balloons” and also as “cenospheres” as well as others) is known. Such glass bubbles are commercially available, such as from Dennert Poraver GmbH, 3M, Zhongke Yali Technology, Ltd, Fibre Glast Developments Corp., Potters Industries LLC, and others. The glass bubbles can be integrated in composite materials for buoyant, load-bearing structures, such as surf boards or supports for offshore drilling equipment. The glass bubbles can also be incorporated into concrete. In these and other typical uses, the glass bubbles are included as filler to reduce material costs and/or to adjust the weight or density of the resulting composition structure. The amount of glass bubbles in the composite structure may be limited to ensure mechanical integrity.

An area that may benefit from the use of glass bubbles is substrates or structures for capture of target gases, such as carbon dioxide (CO₂). CO₂ has steadily increased in the atmosphere since the Industrial Revolution due to fossil fuel combustion technologies like coal-fired power plants and gasoline/diesel-based automobiles. In response to the concern over global warming as CO₂ levels increase, the global community has entered into agreements to control CO₂ emission and/or capture CO₂ to achieve net zero CO₂ emission in the future.

One solution is to use solid adsorbent to capture CO₂ directly from the air (known as direct air capture or DAC) or to capture CO₂ from highly concentrated sources such as power plant flues (known as point source capture). Ceramic honeycomb structures are considered important potential carriers of solid adsorbent to capture CO₂. However, the potential implementation of any CO₂ capture device or system involves consideration of important factors, such as performance and economy.

Some existing ceramic honeycomb structures that may be useful for CO₂ capture applications are those structures integrated in engine aftertreatment systems to capture fine particulates and/or decompose the SO₂ and NOₓ from diesel and gasoline engine exhausts. Such ceramic honeycomb structures have several advantages, including lower pressure drop and, in turn, lower energy consumption over their lifetime, the ability to be regenerated, long lifetime, less solid waste, and lower cost of ownership over their life cycle. The honeycomb structures used in such engine aftertreatment system are typically ceramic-based (e.g., cordierite, aluminum titanate (AT), silicon carbide (SiC), etc.) and configured to withstand high temperatures (e.g., 800° C. or higher) and high thermal shocks.

However, such temperature-related properties are not necessary for CO₂ capture from ambient air or flue gas. Moreover, CO₂ is usually desorbed from the solid adsorbent after capture using methods such as temperature swing adsorption (TSA), which is often used for low CO₂ concentration applications such as encountered with DAC. The thermal energy input for desorption is one of the most significant costs in operating such TSA-based capture systems. Thus, light weight and low density are important attributes for carrier structures implemented for CO₂ capture. Consequently, it would be advantageous to develop low-cost, porous structures with these and other attributes that enable scale up of CO₂ capture systems.

### SUMMARY

A first aspect of the present disclosure includes a porous structure, comprising: a plurality of glass bubbles, wherein the glass bubbles are sintered to one another such that adjoining glass bubbles are physically bonded directly to one another, wherein the glass bubbles have surfaces that define interstices throughout the porous structure, the interstices comprising closed interstices that do not open to surfaces of the porous structure, wherein at least 50% of the glass bubbles are closed glass bubbles, each closed glass bubble defining a sealed void therein, wherein the porous structure has at least 10% closed porosity in terms of volume, the closed porosity comprising the sealed voids and the closed interstices, and wherein the porous structure has at least 40% open porosity in terms of volume.

A second aspect of the present disclosure includes a porous structure according to the first aspect, wherein, in terms of weight, the porous structure comprises mostly glass.

A third aspect of the present disclosure includes a porous structure according to the first aspect or the second aspect, wherein, in terms of weight, the porous structure comprises at least 90% of glass.

A fourth aspect of the present disclosure includes a porous structure according to any of the first through third aspects, wherein, in terms of weight, the porous structure comprises at least 85% of amorphous-phase glass.

A fifth aspect of the present disclosure includes a porous structure according to any of the first through third aspects, wherein, in terms of weight, the porous structure comprises about 100% of amorphous-phase glass.

A sixth aspect of the present disclosure includes a porous structure according to any of the first through fifth aspects, wherein from about 65% to about 100% of the glass bubbles are closed.

A seventh aspect of the present disclosure includes a porous structure according to any of the first through fifth aspects, wherein from about 75% to about 100% of the glass bubbles are closed.

An eighth aspect of the present disclosure includes a porous structure according to any of the first through fifth aspects, wherein from about 85% to about 100% of the glass bubbles are closed.

A ninth aspect of the present disclosure includes a porous structure according to any of the first through fifth aspects, wherein from about 90% to about 100% of the glass bubbles are closed.

A tenth aspect of the present disclosure includes a porous structure according to any of the first through ninth aspects, wherein, in terms of weight, the porous structure comprises: from about 0% to about 40% of further inorganics, and at least about 55% of the glass bubbles.

An eleventh aspect of the present disclosure includes a porous structure according to the tenth aspect, wherein, in terms of weight, the porous structure comprises from about 20% to about 40% of the further inorganics.

A twelfth aspect of the present disclosure includes a porous structure according to the tenth aspect, wherein, in terms of weight, the porous structure comprises at least about 95% of the glass bubbles.

A thirteenth aspect of the present disclosure includes a porous structure according to any of the first through twelfth aspects, wherein the porous structure has at least 20% closed porosity in terms of volume.

A fourteenth aspect of the present disclosure includes a porous structure according to any of the first through twelfth aspects, wherein the porous structure has at least 30% closed porosity in terms of volume.

A fifteenth aspect of the present disclosure includes a porous structure according to any of the first through twelfth aspects, wherein, in terms of volume, the porous structure has from about 10% to about 40% closed porosity.

A sixteenth aspect of the present disclosure includes a porous structure according to any of the first through fifteenth aspects, wherein, in terms of volume, the porous structure has from about 40% to about 70% open porosity.

A seventeenth aspect of the present disclosure includes a porous structure according to any of the first through sixteenth aspects, wherein the porous structure has a cellular honeycomb geometry with a web thickness in a range of from about 2 to about 15 mils and a cell density in a range of from about 50 to about 400 cells per square inch.

An eighteenth aspect of the present disclosure includes a porous structure according to any of the first through seventeenth aspects, wherein the porous structure has a bulk density in a range of from about 0.4 g/cm³ to about 0.6 g/cm³.

A nineteenth aspect of the present disclosure includes a porous structure according to any of the first through eighteenth aspects, wherein the interstices comprise open interstices that open to the surfaces of the porous structure so as to define pores, the pores having a pore size distribution with a median pore size in a range of from about 0.008 μm to about 40 μm.

A twentieth aspect of the present disclosure includes a porous structure, comprising: an inorganic skeleton comprising at least about 55 wt % of a plurality of glass bubbles and from about 0 wt % to about 40 wt % of further inorganics based on a total weight of the inorganic skeleton, wherein the glass bubbles are sintered to one another such that adjoining glass bubbles are physically bonded directly to one another, wherein most of the glass bubbles are closed, and wherein the porous structure has at least 50% total porosity in terms of volume.

A twenty first aspect of the present disclosure includes a porous structure according to the twentieth aspect, wherein the porous structure comprises at least 90 wt % of the inorganic skeleton based on a total weight of the porous structure.

A twenty second aspect of the present disclosure includes a porous structure according to the twenty first aspect, wherein from about 75% to about 100% of the glass bubbles are closed.

A twenty third aspect of the present disclosure includes a porous structure according to any of the twentieth through twenty second aspects, wherein, in terms of weight, the porous structure comprises at least 90% of amorphous-phase glass.

A twenty fourth aspect of the present disclosure includes a porous structure according to any of the twentieth through twenty third aspects, wherein, in terms of weight, the porous structure comprises from about 20% to about 40% of the further inorganics.

A twenty fifth aspect of the present disclosure includes a porous structure according to any of the twentieth through twenty third aspects, wherein, in terms of weight, the porous structure comprises at least about 95% of the glass bubbles.

A twenty sixth aspect of the present disclosure includes a porous structure according to any of the twentieth through twenty fifth aspects, wherein the porous structure comprises from about 10% to about 40% closed porosity in terms of volume.

A twenty seventh aspect of the present disclosure includes a porous structure according to any of the twentieth through twenty sixth aspects, wherein the porous structure comprises from about 40% to about 70% open porosity in terms of volume.

A twenty eighth aspect of the present disclosure includes a method of making a porous structure, comprising: bonding a plurality of glass bubbles to one another, wherein the glass bubbles have a median particle size in a range of from about 1 μm to about 100 μm, and wherein the plurality comprises at least 1000 of the glass bubbles; and heating the glass bubbles, wherein substantially all of the glass bubbles are closed prior to the heating, substantially all adjoining glass bubbles sinter to one another during the heating, and at least 50% of the glass bubbles remain closed after the heating such that, in aggregate, the sintered, closed glass bubbles form the porous structure, wherein each of the closed glass bubbles defines a sealed void therein, and wherein surfaces of the sintered glass bubbles define interstices throughout the porous structure, the interstices comprising closed interstices that do not open to surfaces of the porous structure, wherein the porous structure has at least 10% closed porosity in terms of volume, the closed porosity comprising the sealed voids and the closed interstices.

A twenty ninth aspect of the present disclosure includes a method according to the twenty eighth aspect, wherein from about 75% to about 100% of the glass bubbles remain closed after the heating.

A thirtieth aspect of the present disclosure includes a method according to the twenty eighth aspect, wherein from about 90% to about 100% of the glass bubbles remain closed after the heating.

A thirty first aspect of the present disclosure includes a method according to any of the twenty eighth through thirtieth aspects, wherein the heating comprises heating the glass bubbles to at least a softening temperature of amorphous glass of the glass bubbles.

A thirty second aspect of the present disclosure includes a method according to any of the twenty eighth through thirty first aspects, further comprising, prior to the heating, extruding green material comprising the glass bubbles, an organic binder, and optionally further inorganics, wherein substantially all of the glass bubbles remain closed after the extruding.

A thirty third aspect of the present disclosure includes a method according to the thirty second aspect, wherein the extruding comprises extruding thousands of the glass bubbles coupled to one another with the organic binder.

A thirty fourth aspect of the present disclosure includes a method according to the thirty second aspect or the thirty third aspect, wherein: the green material further comprises a liquids portion comprising one or more of oil and water, the glass bubbles, the organic binder, and the optional further inorganics define a solids portion of the green material, and the solids portion is greater than the liquids portion in terms of weight.

A thirty fifth aspect of the present disclosure includes a method according to the thirty fourth aspect, wherein, in terms of weight, the solids portion is at least 10% greater than the liquids portion of the green material.

A thirty sixth aspect of the present disclosure includes a method according to the thirty fourth aspect or the thirty fifth aspect, wherein, in terms of weight, the green material comprises at least 55% of the solids portion.

A thirty seventh aspect of the present disclosure includes a method according to any of the thirty fourth through thirty sixth aspects, wherein a ratio of a weight of the solids portion to a weight of the liquids portion is in a range of from about 1.2 to about 1.7.

A thirty eighth aspect of the present disclosure includes a method according to any of the thirty fourth through thirty seventh aspects, wherein, in terms of weight, the green material comprises: at least about 30% of the glass bubbles, from about 3% to about 10% of the organic binder, from about 0% to about 25% of the optional further inorganics, and from about 35% to about 45% of the liquids portion.

A thirty ninth aspect of the present disclosure includes a method according to any of the thirty fourth through thirty eighth aspects, wherein the heating one or more of burns out or chemically changes most of the organic binder and the liquids portion.

A fortieth aspect of the present disclosure includes a method according to any of the thirty second through thirty ninth aspects, wherein the further inorganics comprise one or more of clay, talc, sepiolite, bentonite, CaCO₃, Na₂CO₃, NaHCO₃, ZrO₂, Al₂O₂, MgO, and SiO₂.

A forty first aspect of the present disclosure includes a method according to any of the twenty eighth through fortieth aspects, wherein, during the heating, the glass bubbles are heated to a first temperature range for a first dwell time, and then heated to a second temperature range for a second dwell time, wherein the first temperature range is from about 200° C. to about 400° C.; and wherein the first dwell time is in a range from about 2 hours to about 6 hours.

A forty second aspect of the present disclosure includes a method according to the forty first aspect, wherein, during the heating, the second temperature range is from about 450° C. to 800° C. and the second dwell time is in a range from about 3 hours to 7 hours.

A forty third aspect of the present disclosure includes a method according to the forty first aspect, wherein, during the heating, the second temperature range is from about 500° C. to 700° C. and the second dwell time is in a range from about 3 hours to 7 hours.

A forty fourth aspect of the present disclosure includes a method according to the forty first aspect, wherein, during the heating, the second temperature range is above 400° C. and below a devitrification temperature of amorphous glass of the glass bubbles, and wherein the second dwell time is in a range from about 3 hours to 7 hours.

A forty fifth aspect of the present disclosure includes a method according to any of the twenty eighth through forty fourth aspects, further comprising cooling the plurality of glass bubbles with the adjoining, closed glass bubbles physically bonded directly to one another.

### BRIEF DESCRIPTION OF THE DRAWINGS

FIG. 1 is a perspective view of a porous structure according to aspects of the disclosure;

FIG. 2 is a perspective view of another porous structure according to aspects of the disclosure;

FIG. 3 is a micrograph of a green structure that includes a high percentage of glass bubbles, in terms of weight, according to an exemplary embodiment;

FIG. 4 is a scanning electron microscope (SEM) image of a porous structure formed by firing the green structure of FIG. 3, the glass bubbles fused together and remaining closed after the firing;

FIG. 5 is an enlarged portion of the SEM image of FIG. 4, showing substantially all of the fused glass bubbles are closed after the firing; and

FIG. 6 is a graph showing pore size distributions associated with porous structures formed using exemplary glass bubbles.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein, unless defined elsewhere in association with specific terms or phrases, are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom, above, below, and the like—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, a “particle size distribution” or “PSD” is series of values, a histogram, or a mathematical function that defines the relative quantity of particles, such as the glass bubbles disclosed herein, present according to size. A PSD is useful way to describe the size(s) of the particles in a collection of particles. A PSD can be described by numerous features of the distribution such as mean, median, mode, and width or span. Mean is a calculated value similar to the concept of average. There are multiple definitions for mean because the mean value is associated with the basis of the distribution calculation (number, surface, volume). The various mean calculations are defined by known standards such as ISO 9276-2:2001. Median values are defined as the value where half of the population resides above this point and half resides below this point. For particle size distributions, the median is called the D50. The D50 is the size (diameter) in microns that splits the distribution with half above and half below this diameter. D90 and D10 are other common values reported in a PSD. The D90 is the size (diameter) at which 90% of the distribution lies below this diameter, and the D10 is the size (diameter) at which 10% of the distribution lies below this diameter. The mode is the peak of the frequency distribution, or the highest peak seen in the distribution. The mode represents the particle size (or size range) most commonly found in the distribution. The values for particles size disclosed herein refer to the diameter or the equivalent spherical diameter for the particles unless indicated otherwise.

As used herein, a “pore size distribution” is an analysis of the pores of a porous material, such as the inventive porous structures disclosed herein, to characterize the pore diameter at which a specified percentage of the total pore volume is of a finer pore diameter. Thus, for example, d1, d5, d10, d50, d90, d95, and d99 denote the pore diameters at which 1%, 5%, 10%, 50%, 90%, 95%, and 99% of the total pore volume are of a finer pore diameter, respectively. Volume percent porosity and pore size distribution as used herein are measured by mercury porosimetry on examples of the inventive porous structures, as per known standards such as ASTM D4284-12. All pore size distributions are on a pore volume basis. In particular, the parameters d10, d50 and d90 are used herein, among other parameters, to define the relative narrowness of the pore size distribution. The parameters used to describe pore size distribution (i.e., d10, d50, and d90) are conceptually similar to the parameters used to describe particle size distribution (i.e., D10, D50, and D90). For example, the quantity d50 is the median pore diameter based upon pore volume and is measured in μm. Thus, d50 is the pore diameter at which 50/o of the open porosity of the ceramic honeycomb article has been intruded by mercury. The quantity d90 is the pore diameter at which 90% of the pore volume is comprised of pores whose diameters are smaller than the value of d90. Thus, d90 is equal to the pore diameter at which 10% by volume of the open porosity of the ceramic has been intruded by mercury. The quantity d10 is the pore diameter at which 10% of the pore volume is comprised of pores whose diameters are smaller than the value of d10. Thus, d10 is equal to the pore diameter at which 90% by volume of the open porosity of the ceramic has been intruded by mercury. The values of d10 and d90 are also in units of microns.

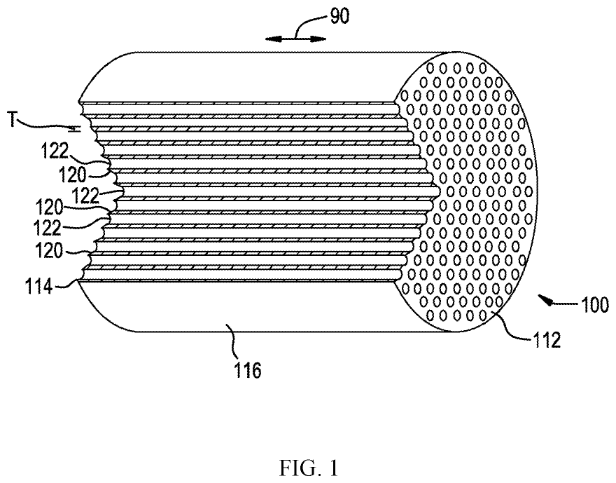

FIG. 1 depicts a lightweight, porous substrate or structure 100 according to the present disclosure for use in numerous applications, such as CO₂ capture. The porous structure 100 can include a plurality of porous partition walls 120 that define a plurality of open channels 122. The porous partition walls 120 each have a thickness T between opposite surfaces which define the plurality of open channels 122. The open channels 122 can extend in an axial direction 90 from an inlet end 112 to an outlet end 114 of the porous structure 100. In embodiments, the plurality of partition walls 120 intersect to form a honeycomb structure as shown in FIG. 1. While the porous structure 100 is depicted in FIG. 1 with channels 122 having a substantially circular cross-section (e.g., in a plane perpendicular to the axial direction 90), in embodiments the channels can have any suitable geometry, for example, hexagonal, square, triangular, rectangular, or sinusoidal cross-sections, or any combination thereof. Additionally, although the porous structure 100 is depicted as substantially cylindrical in shape, it is to be understand that such shape is exemplary only and the porous structure can have any variety of shapes including, but not limited to, spherical, oblong, pyramidal, cubic, or block shapes, for example.

The open channels 122 in embodiments can have relatively high aspect ratios, such as length-to-width or length-to-diameter, where length is oriented along the flow path of the open channels 122 in the axial direction 90. In embodiments, the open channels 122 are elongate such that the aspect ratio, defined as the length of an open channel 122 in relation to the widest cross-sectional dimension of the respective open channel 122 orthogonal to the length, of at least some of (e.g., most, >90%, all) the channels is at least ten, at least twenty, at least fifty, at least one-hundred, and/or no more than 50,000.

The porous structure 100 can also have any variety of configurations and designs including, but not limited to, flow-through monolith, wall-flow monolith, or partial-flow monolith structures. Exemplary flow-through monoliths include any structure comprising open channels 122, porous networks, or other passages through which fluid can flow from one end of the structure 100 to the other. Exemplary wall-flow monoliths include, for example, any monolithic structure comprising open channels 122 or porous networks or other passages which may be open or plugged at opposite ends of the structure, thereby directing fluid flow through partition walls 120 (“wall-flow”) as it flows from one end of the structure to the other. Exemplary partial-flow monoliths can include any combination of a wall-flow monolith with a flow-through monolith, e.g., having some channels or passages open on both ends to permit the fluid to flow through the channel without blockage.

As shown in FIG. 1, the porous structure 100 can also include a porous skin 116 along a peripheral edge or its circumference. The skin 116 can have a thickness of about 0.1 mm to about 3.5 mm, or from about 0.5 mm to about 2.5 mm, or even from about 1 mm to about 2 mm. The skin 116 can have properties (e.g., pore diameter, pore diameter distribution, material, etc.) similar to that of partition walls 120. In embodiments, the skin 116 can be formed by converging partition walls 120. The skin 116 can be applied during or after formation of porous structure 100.

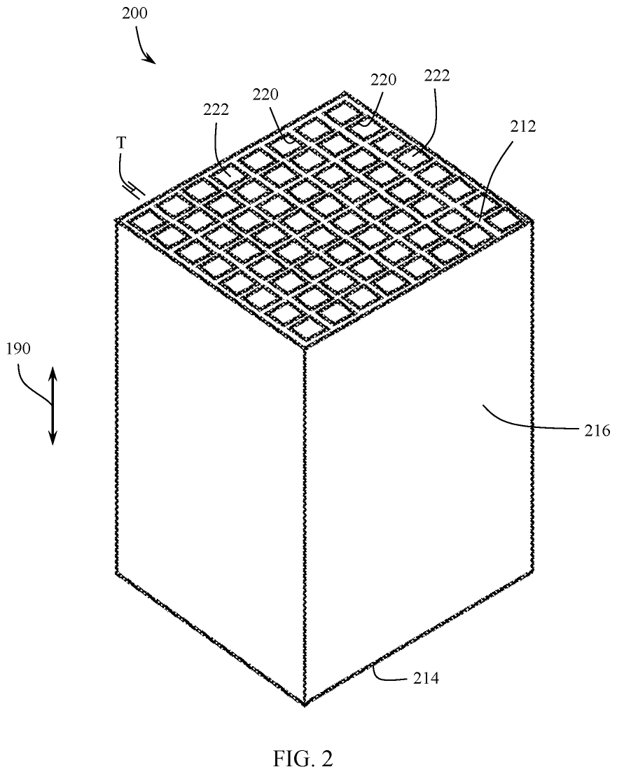

FIG. 2 depicts a porous structure 200 having a different overall geometry and a different channel geometry than the porous structure 100 of FIG. 1. In FIG. 2, features of the porous structure 200 that are substantially similar to features of the porous structure 100 of FIG. 1 use like reference numerals incremented by 100. The porous structure 200 includes a plurality of porous partition walls 220 that define a plurality of open channels 222. The porous partition walls 220 each have a thickness T between opposite surfaces which define the plurality of open channels 222. The open channels 222 extend in an axial direction 190 from an inlet end 212 to an outlet end 214 of the porous structure 200. In embodiments, the plurality of partition walls 220 intersect to form a honeycomb structure as shown in FIG. 2.

The open channels 222 are shown having a substantially square cross-section (e.g., in a plane perpendicular to the axial direction 190) though in embodiments the channels can have any suitable geometry such as described with respect to the porous structure 100 of FIG. 1. The porous structure 200 is depicted having a substantially square shape though in embodiments the structure 200 can have any variety of shapes such as described with respect to the porous structure 100 of FIG. 1. The porous structure 200 can have the same or different configurations (e.g., flow-through monolith, wall-flow monolith, or partial-flow monolith structures) as described with respect to the porous structure 100 of FIG. 1. The porous structure 200 can also include a porous skin 216 along a peripheral edge thereof. The skin 216 can be configured in substantially manner or different than the skin 116 of the porous structure 100 of FIG. 1

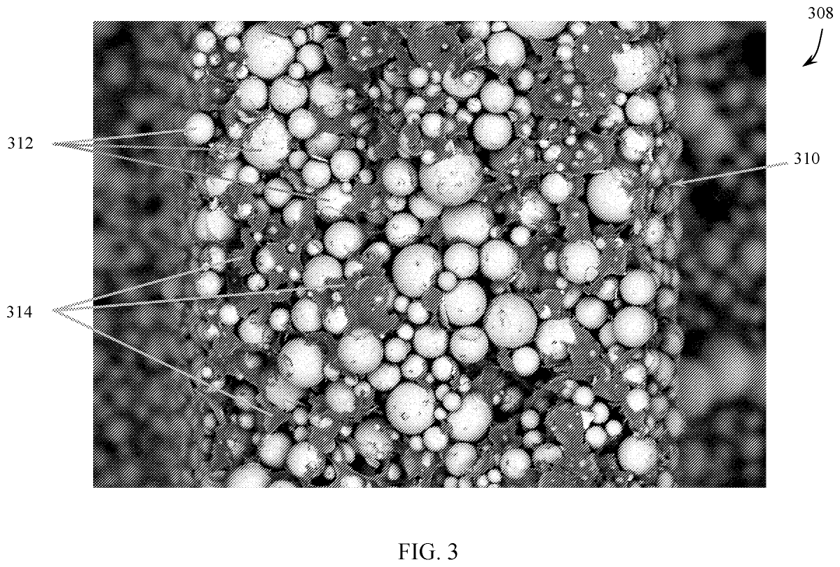

According to embodiments, porous structures, such as the porous structure 100 of FIG. 1 and the porous structure 200 of FIG. 2, include and/or are substantially formed from a plurality of glass bubbles (see glass bubbles 312, 312′ of FIGS. 3-5). As used herein, “plurality” can include more than 100, such as more than 1000. The porous structures of the present disclosure, when formed from the glass bubbles in the amounts and under the processing conditions disclosed herein, are lightweight and have beneficial porosity for applications such as CO₂ capture. For instance, the porous structures of the present disclosure have very low density and mixed porosity with a relatively high closed porosity that can enable loading of carriers, such as on-wall gamma Al₂O₃, for adsorbents, such as polyethylenimine (PET).

The glass bubbles can be characterized by “diameter,” where diameter refers to the diameter if the volume of the glass bubble was arranged in a perfect spherical geometry. In practice, however, the glass bubbles may only be generally spherical, such as having a potato-shape, for example. The size of glass bubbles may be selected and characterized based on the diameter in relation to a particle size distribution of the glass bubbles.

The glass bubbles can have a median or D50 particle size in a range of from about 1 μm to about 1000 μm, or from about 2.5 μm to about 500 μm, or from about 5 μm to about 250 μm, or from about 7.5 μm to about 100 μm, or from about 1 μm to about 100 μm, or from about 7.5 μm to about 50 μm, or from about 10 μm to about 30 μm. The glass bubbles can also have D10 and D90 particle sizes as indicated below in Table 1 in connection with exemplary glass bubbles used to form porous structures according to the methods disclosed herein.

The glass bubbles can include glass (e.g., consist of, consist mostly of by volume, comprise), such as soda lime glass, borosilicate glass, aluminosilicate glass, and/or other glasses.). The glass of the glass bubbles is substantially or fully amorphous in exemplary embodiments. In such exemplary embodiments, the glass of the glass bubbles is substantially or fully amorphous prior to heating and remains substantially (i.e., ≥85%) or fully (i.e., ˜100%) amorphous after heating according to the methods disclosed herein. In some contemplated embodiments, the glass of the glass bubbles can be fully or partially amorphous, crystalline, polycrystalline, etc., such as two-phase glass-ceramic. In such contemplated embodiments, the glass of the glass bubbles can be amorphous prior to heating, and subsequently may devitrify and/or crystallize. In some contemplated embodiments, the glass bubbles can include and/or be formed from other materials, such as synthetic minerals, polymers, ceramics, fly ash/cenospheres, metals, etc.

In embodiments, the glass bubbles have a softening temperature in a range of from about 425° C. to about 825° C., or from about 450° C. to about 800° C., or from about 475° C. to about 750° C., or from about 500° C. to about 700° C., or from about 400° C. to about 675° C. or from greater than 400° C. and less than a devitrification temperature of the amorphous glass of the glass bubbles. In embodiments, the softening temperature corresponds to a peak or maximum temperature of a firing cycle used to form the porous structures according to the methods disclosed herein. In embodiments, the softening temperature is less than about 600° C.

In embodiments, the glass bubbles have a density in a range of from about 0.66 g/cm³ to about 0.90 g/cm³, or from 0.60 g/cm³ to about 1.00 g/cm³, or from about 0.54 g/cm³ to about 1.10 g/cm³, or from about 0.42 g/cm³ to about 1.30 g/cm³, or from about 0.30 g/cm³ to about 1.50 g/cm³, or from 0.48 g/cm³ to about 1.00 g/cm³, or from about 0.36 g/cm³ to about 1.00 g/cm³, or from about 0.24 g/cm³ to about 1.00 g/cm³. The glass bubbles have a density of less than 1.0 g/cm³ in exemplary embodiments. The density as used herein accounts for mass per volume, including interior bubble volume.

In embodiments, the glass bubbles are particularly resilient, such as those having a mean isostatic crush strength of at least 1000 psi, such as at least 2000 psi, such as at least 3000 psi, such as at least 4000 psi, or at least greater than any of these listed strength values. Such crush strength can be measured according to the techniques described in the article “Measuring Isostatic Pressing Strength of Hollow Glass Microspheres by Mercury-injection Apparatus” by Yun, W. and Shou, P., Key Engineering Materials, vol. 544, pp. 460-5 (2013). The methods disclosed herein can enable the porous structures to be formed from glass bubbles having a variety of compositions, physical attributes, and/or properties.

The porous structures of the present disclosure, which include the glass bubbles in the relatively high amounts described later in this disclosure, have a pore size distribution that is beneficial for a variety of applications, such as CO₂ capture. The pore size distribution is described with reference to the parameters d10, d50, d90, which can be used to characterize various attributes of the pore size distribution, such as pore distribution breadth and d-factor. In embodiments, porous structures of the present disclosure have a median or d50 pore size in a range from about 0.005 μm to about 10 μm, or from about 0.010 μm to about 8 μm, or from about 0.010 μm to about 6 μm, or from about 0.015 μm to about 5 μm, or from about 0.015 to about 4 μm, or a range larger or smaller than indicated here.

A pore distribution breadth, db, as used herein is a measure of the overall breadth of the pore size distribution of the porous partition walls of the porous structure, i.e., the overall narrowness of the large/coarse pore fraction (larger than d50) of the pore size distribution of the material that forms the partition walls. The pore distribution breadth db is given by the following relationship: db=(d90−d10)/d50. According to embodiments, the porous structures including the glass bubbles have a pore distribution breadth db in a range of from about 1.00 to about 1000, or from about 1.50 to about 975, or from about 2.00 to about 950. In embodiments in which the porous structures include further inorganics (e.g., MgO or a source of magnesium or other inorganics disclosed herein), the pore distribution breadth db is in a range of from about 1.50 to about 50.0, or from about 1.75 to about 25.0, or from about 2.00 to about 10.0, or from about 2.25 to about 5.00, or from about 2.25 to about 3.25.

A d-factor, df, as used herein is a measure to characterize the relative narrowness of the small pore size portion (smaller than d50) of the pore size distribution. The d-factor df is given by the following relationship: df=(d50−d10)/d50. According to embodiments, the porous structures including the glass bubbles have a d-factor df in a range of from about 0.10 to about 1.00, or from about 0.15 to about 0.95, or from about 0.20 to about 0.90, or from about 0.25 to about 0.85, or from about 0.3 to about 0.80, or from about 0.35 to about 0.75, or from about 0.30 to about 1.00, or from about 0.10 to about 0.75.

In embodiments, the porous structures of the present disclosure, in terms of weight, are mostly glass, such as at least 70% of the weight, or at least 80% of the weight, or at least 90% of the weight. Such large portions of the porous structures formed from the glass of the glass bubbles may be surprising or counterintuitive for those in industry because they may expect such structures to be particularly fragile and/or not maintain mechanical integrity. However, in some contemplated uses, the open porosity of the porous structures of the present disclosure can be at least partially filled by other materials (e.g., solid adsorbents for CO₂ capture), while the porous structures hold together largely due to the methods of making such structures as disclosed herein.

FIG. 3 is a micrograph of a “green” (e.g., pre-fired, pre-sintered) structure 308 with surface portions such as the surface portion 310 shown in the foreground of the micrograph. The green structure 308 is configured to form a body of the porous structure, such as the porous structure 100 of FIG. 1 and the porous structure 200 of FIG. 2, after firing the green body 308 according to the methods disclosed herein. The surface portions 310 may form exterior walls or interior walls (or webs) of the porous structure after firing.

The green structure 308 in an exemplary embodiment can be formed from extruded batch material that comprises the glass bubbles 312 held in binder 314 (e.g., organic binder, or mostly-organic binder). The glass bubbles 312 are hollow and preferably have walls configured to be relatively resilient. Such resiliency enables the glass bubbles 312 to remain closed (i.e., intact, and not breached) during extrusion and after firing, resulting in mixed porosity structures with relatively high closed porosity. As previously mentioned, the methods disclosed herein can enable the porous structures to be formed from a wide variety of readily available glass bubbles. The attributes of some exemplary glass bubbles configured for use in the methods disclosed herein are provided below in Table 1. The attribute values marked with an asterisk (*) were estimated according to SEM results.

TABLE 1
Attributes of Exemplary Glass Bubbles

| | Sample | | |
|---|---|---|---|
| Attribute | A | B | C |
| Glass Type | Soda-lime | Soda-lime | Borosilicate |
| Softening Temperature | 500* | 600* | 800* |
| (° C.) | | | |
| Density (g/cm³) | 1.0 | 0.82 | 0.60 |
| Shell Thickness (μm) | 1-2* | 1-2* | 1-2* |
| Particle Size D₁₀ (μm) | 0.6 | 6 | 15 |
| Particle Size D₅₀ (μm) | 13 | 15 | 28 |
| Particle Size D₉₀ (μm) | 30 | 30 | 51 |
| Db = (D90 − D10)/D50 | 2.26 | 1.60 | 1.29 |
| Df = (D50 − D10)/D50 | 0.95 | 0.60 | 0.46 |
| Crush strength (psi) | 1000 | 5000 | 11000 |

The exemplary glass bubbles of Table 1 have compositions that can be described by the following, non-limiting ranges: from about 40 wt % to about 90 wt % SiO₂; from about 2 wt % to about 10 wt % CaO; from about 3 wt % to about 35 wt % B₂O₃; from about 0 wt % to about 5 wt % Al₂O₃; from about 0 wt % to about 1 wt % Fe₂O₃; from about 4 wt % to about 20 wt % Na₂O; from about 0 wt % to about 1 wt % K₂O; and from about 0 wt % to about 5 wt % MgO. In embodiments, the porous structures of the present disclosure can be formed from glass bubbles having compositions with different amounts of the indicated constituents and/or compositions with different constituents in amounts that can be different than or similar to the indicated constituents.

The glass bubbles 312 in the batch material can have a particle size distribution breadth, Db, given by the relationship: Db=(D90−D10)/D50. In embodiments, the glass bubbles 312 have a particle distribution breadth Db of less than 3, or less than 2.75, or less than 2.5, or less than 2.4, or less than 2.3, or less than 2, or less than 1.75, or less than 1.6, or less than 1.5, or less than 1.3, or less than 1. The glass bubbles 312 in the batch material can have a d-factor, Df, given by the relationship: Df=(D50−D10)/D50. In embodiments, the glass bubbles 312 have a d-factor Df of less than 1.25, or less than 1.2, or less than 1.1, or less than 1.0, or less than 0.95, or less than 0.85, or less than 0.75, or less than 0.7, or less than 0.65, or less than 0.6, or less than 0.55, or less than 0.5, or less than 0.4.

In embodiments, the batch material that forms the green structure 308 can include various additives to facilitate processing, such as processing via extrusion. For example, the batch material can include a slip agent and/or lubricant, such as oil. In embodiments, one or more sintering aids, such as such as sodium stearate, can be added to the batch material. In embodiments, the binder can include methylcellulose, carboxymethycellulose, hydroxypropyl methylcellulose, and/or other binders. In embodiments, the batch material can include a pore former, such as an organic pore former, such as a starch (e.g., corn starch, pea starch). Water, such as deionized water or DIW, can be added to the batch material to facilitate processing. In embodiments, the oil and the water define a liquids portion of the batch material.

In embodiments, the batch material comprises mostly (i.e., >50 wt %) inorganic constituents based on a total weight of the inorganic constituents and organic constituents (i.e., organic binder) in the batch material. For example, the batch material can comprise at least 55 wt %, or at least 60 wt %, or at least 75 wt %, or at least 80 wt %, or at least 85 wt %, or at least 90 wt % of the inorganic constituents whereas the remainder of the batch material substantially comprises the organic constituents. In an exemplary embodiment, the glass bubbles 312 can be a “stand-alone” composition in terms of the inorganic constituents such that the batch material comprises at least 55 wt %, or at least 60 wt %, or at least 75 wt %, or at least 80 wt %, or at least 85 wt %, or at least 90 wt % of the glass bubbles 312.

In embodiments, the batch material that forms the green structure 308 can include additional or further inorganic material (hereinafter “further inorganics”), such as clay, talc, silica, alumina, minerals, synthetic oxides, other types of glass or ceramic particles and/or bubbles. In embodiments, the further inorganics have a softening temperature that is different than the softening temperature of the glass bubbles so as to influence the softening temperature of the inorganic constituents in the batch material. In an exemplary embodiment, the further inorganics comprise a source of magnesium (e.g., MgO). In embodiments, the further inorganics are one or more of clay, talc, sepiolite, bentonite, CaCO₃, Na₂CO₃, NaHCO₃, ZrO₂, Al₂O₂, and SiO₂. In embodiments, the further inorganics are one or more of clay, talc, sepiolite, bentonite, CaCO₃, Na₂CO₃, NaHCO₃, ZrO₂, Al₂O₂, MgO, and SiO₂.

The glass bubbles, the organic binder, and optionally the further inorganics can define a solids portion of the batch material. In embodiments, the batch material comprises mostly (i.e., >50 wt %) the solids portion based on a total weight of the solids portion and the liquids portion of the batch material. For example, the batch material in embodiments can comprise from about 50.1 wt % to about 70 wt %, or from about 51 wt % to about 69 wt %, or from about 52 wt % to about 67 wt %, or from about 53 wt % to about 65 wt %, or from about 54 wt % to about 64 wt %, or from about 55 wt % to about 63 wt % of the solids portion whereas the remainder of the batch material substantially comprises the liquids portion.

In embodiments, the batch material comprises a ratio of a weight of the solids portion to a weight of the liquids portion. For example, the ratio of the solids portion to the liquids portion, in terms of weight, is greater than 1 such as at least 1.05, or 1.1, or 1.2, or 1.3, or 1.4, and at most 2.5, or 2, or 1.9, or 1.8, or 1.7.

In embodiments, the batch material can comprise the glass bubbles, the further inorganics, and the organic binder. For example, the batch material in embodiments can comprise from about 25 wt % to about 60 wt %, or from about 27 wt % to about 58 wt %, or from about 29 wt % to about 55 wt %, or from about 30 wt % to about 53 wt %, or from about 31 wt % to about 50 wt %, or from about 32 wt % to about 49 wt %, or from about 33 wt % to about 48 wt % of the glass bubbles based on a total weight of the batch material. The batch material in embodiments can comprise from about 0 wt % to about 35 wt %, or from about 3 wt % to about 33 wt %, or from about 5 wt % to about 30 wt %, or from about 7 wt % to about 29 wt %, or from about 10 wt % to about 25 wt %, or from about 15 wt % to about 20 wt %, or from about 0 wt % to about 25 wt % of the further inorganics and/or the source of magnesium based on the total weight of the batch material.

The batch material in embodiments can comprise from about 2.5 wt % to about 10 wt %, or from about 2.75 wt % to about 9 wt %, or from about 2.9 wt % to about 8.5 wt %, or from about 3 wt % to about 8 wt %, or from about 3 wt % to about 10 wt %, or from about 3.1 wt % to about 7.75 wt %, or from about 3.2 wt % to about 7.5 wt % of the organic binder based on the total weight of the batch material. The batch material in embodiments can comprise from about 0.5 wt % to about 4 wt %, or from about 0.75 wt % to about 3 wt %, or from about 1 wt % to about 2 wt %, or from about 1.25 wt % to about 2 wt %, or from about 1.3 wt % to about 1.9 wt % of the oil based on the total weight of the batch material. The batch material in embodiments can comprise from about 25 wt % to about 55 wt %, or from about 27.5 wt % to about 50 wt %, or from about 29 wt % to about 48 wt %, or from about 30 wt % to about 46 wt %, or from about 32.5 wt % to about 45 wt %, or from about 33 wt % to about 44 wt %, or from about 35 wt % to about 41 wt % of the water based on the total weight of the batch material.

In embodiments that include the glass bubbles and the further inorganics, the amount of the glass bubbles is greater than the amount of the further inorganics in the batch material. For example, the amount of the glass bubbles is at least 5 wt %, or at least 10 wt %, or at least 15 wt %, or at least 20 wt % greater than the amount of the further inorganics based on the total weight of the inorganic constituents and the organic constituents in the batch material.

Some exemplary batch compositions for the batch material are provided below in Table 2. The exemplary batch compositions include the exemplary glass bubbles disclosed in Table 1. The column header “Glass Bubble Sample” in Table 2 refers to the Sample identification of the exemplary glass bubbles disclosed in Table 1 (i.e., Sample A, B, or C). For instance, the batch composition of Sample 2-3 comprises the glass bubbles of Sample A, the batch compositions of Sample 2-1 and Sample 2-2 each comprise the glass bubbles of Sample B, and the batch composition of Sample 2-4 comprises the glass bubbles of Sample C. The weight percentages (wt %) listed in Table 2 are based on the total weight of the batch material. The abbreviations “MC,” “CMC,” and “HPMC,” in Table 2 under the heading “Binder Type” refer to methylcellulose, carboxymethycellulose, and hydroxypropyl methylcellulose, respectively. In Table 2, any aqueous portion of the binder is included in the row header “Water (g)” and the remaining solid portion is included in the row header “Binder Weight (g)”.

TABLE 2
Exemplary Batch Compositions

| | Sample | | | |
|---|---|---|---|---|
| Description | 2-1 | 2-2 | 2-3 | 2-4 |

Solids - Inorganics

| | | | | |
|---|---|---|---|---|
| Glass Bubble Sample | B | B | A | C |
| Glass Bubble Weight (g) | 200 | 170 | 170 | 200 |
| MgO Weight (g) | 0 | 107.4 | 107.4 | 0 |
| Total Inorganics Weight (g) | 200 | 277.4 | 277.4 | 200 |

Solids - Organics

| | | | | |
|---|---|---|---|---|
| Binder Type | MC | MC | CMC | HPMC |
| Binder Weight (g) | 30 | 30 | 17.1 | 30 |

Liquids

| | | | | |
|---|---|---|---|---|
| Oil (g) | 8 | 8 | 8 | 8 |
| Water (g) | 180 | 175 | 212.9 | 180 |
| Total Liquids Weight (g) | 188 | 183 | 220.9 | 188 |

Solids + Liquids

| | | | | |
|---|---|---|---|---|
| Total Weight (g) | 418 | 490.4 | 515.4 | 418 |
| Glass Bubble Weight % (wt %) | 47.85% | 34.67% | 32.98% | 47.85% |
| MgO Weight % (wt %) | 0% | 21.90% | 20.84% | 0% |
| Inorganics Weight % (wt %) | 47.85% | 56.57% | 53.82% | 47.85% |
| Organics Weight % (wt %) | 7.18% | 6.12% | 3.32% | 7.18% |
| Total Solids Weight % (wt %) | 55.02% | 62.68% | 57.14% | 55.02% |
| Oil Weight % (wt %) | 1.91% | 1.63% | 1.55% | 1.91% |
| Water Weight % (wt %) | 43.06% | 35.69% | 41.31% | 43.06% |
| Total Liquids Weight % (wt %) | 44.98% | 37.32% | 42.86% | 44.98% |

According to embodiments, the glass bubbles 312 in the binder 314 have been extruded (e.g., via a twin-screw extruder) at a rate and pressure configured to preserve integrity of most (e.g., more than 75%, or more than 80%, or more than 85%, or more than 90%, or more than 95%) of the glass bubbles 312 in the batch material. As shown in FIG. 3, most of the glass bubbles 312 appear fully intact. Preserving the integrity of the glass bubbles 312 allows the glass bubbles to occupy relatively large volumes of space within the green structure 308 with interstices defined between the glass bubbles 312 and respective sealed voids defined within each of the closed glass bubbles 312. It will be appreciated that rates and pressures through the corresponding extruder may vary depending upon the size of the glass bubbles, the material of the glass bubbles, and the extruding device. In embodiments, extrusion pressures are in a range of less than 2500 psi, such as less than 2000 psi, and/or at least 500 psi.

Extruding the green structure 308 can be particularly efficient for forming through-channels (e.g., channels 122 in FIG. 1, channels 222 in FIG. 2) in porous structures, such as the porous structure 100 of FIG. 1 and the porous structure 200 of FIG. 2, or other through-features in the green structure 308. However, in contemplated embodiments, such porous structures including the glass bubbles in binder can be molded, tape-cast, or otherwise shaped or processed, which can better or alternatively preserve the integrity of the glass bubbles 312. In contemplated embodiments, porous structures with shapes substantially different from those of the porous structures 100, 200 can be extruded or otherwise formed.

In embodiments, the green structure 308 is dried and heated (e.g., fired/sintered in a furnace, laser heated) according to the methods described herein to form the porous structure of the present disclosure. The heating is configured to burn out substantially all of the liquids portion, including the oil and water. The heating is configured to burn out, char, chemically transform, or otherwise influence the binder 314. In embodiments, the heating is such that at least 75%, or at least 80%, or at least 85%, or at least 90%, or at least 95%, or at least 96%, or at least 97%, or at least 98%, or more of the binder is removed during the heating. Table 3 provides estimated compositions from firing green structures 308 that include the respective batch compositions of Table 2 after about 90% of the binder and substantially all (e.g., ˜100%) of the liquids portion are removed during heating according to the methods described herein.

TABLE 3
Estimated Compositions after Firing the Batch Compositions of Table 2

| | Sample | | | |
|---|---|---|---|---|
| Description | 2-1′ | 2- 2′ | 2-3′ | 2-4′ |

Inorganics

| | | | | |
|---|---|---|---|---|
| Glass Bubble Sample | B | B | A | C |
| Glass Bubble Weight (g) | 200 | 170 | 170 | 200 |
| MgO Weight (g) | 0 | 107.4 | 107.4 | 0 |
| Total Inorganics Weight (g) | 200 | 277.4 | 277.4 | 200 |

Organics

| | | | | |
|---|---|---|---|---|
| Binder Type | MC | MC | CMC | HPMC |
| Binder Weight (g) | 3 | 3 | 1.71 | 3 |

Inorganics + Organics

| | | | | |
|---|---|---|---|---|
| Total Weight (g) | 203 | 280.4 | 279.1 | 203 |
| Glass Bubble Weight % (wt %) | 98.52% | 60.63% | 60.91% | 98.52% |
| MgO Weight % (wt %) | 0% | 38.30% | 38.48% | 0% |
| Inorganics Weight % (wt %) | 98.52% | 98.93% | 99.39% | 98.52% |
| Organics Weight % (wt %) | 1.48% | 1.07% | 0.61% | 1.48% |

The compositions listed in Tables 2 and 3 are related in that the estimated compositions of Examples 2-1′ through 2-4′ of Table 3 are based on the batch compositions of Examples 2-1 through 2-4, respectively, of Table 2. In view of this relationship, it will be appreciated that the composition ranges discussed above in connection with embodiments of the batch material can be adjusted to provide the compositions of fired porous structures based on the amount of the binder and/or liquids portion removed during the heating. For example, the porous structure of the present disclosure can comprise from about 0 wt % to about 40 wt % of further inorganics (e.g., MgO) and at least about 55 wt % of the glass bubbles based on a total weight of the inorganics and organics in the porous structure after the heating/firing. In embodiments, the porous structure can comprise from about 20 wt % to about 40 wt % of further inorganics (e.g., MgO) based on a total weight of the inorganics and organics in the porous structure after the heating/firing. In embodiments, the porous structure can comprise at least about 95 wt % of the glass bubbles based on a total weight of the inorganics and organics in the porous structure after the heating/firing.

In embodiments, the green structure 308 is heated to at least a softening temperature of the (amorphous) glass of the glass bubbles 312 and at most less than a devitrification temperature of the (amorphous) glass of the glass bubbles 312. The conditions and handling of the green structure 308 during the heating are configured such that adjoining glass bubbles 312 physically interact with one another, such as directly bond to one another (e.g., sinter, weld, melt-into), but without fully losing their individual structures. In other words, the conditions and handling of the green structure 308 are configured such that the glass bubbles 312 do not fully liquify and/or completely lose structure and, instead, the glass bubbles 312 become bonded to one another such that, in the aggregate, the resulting structure is cohesive and rigid. This cohesive and rigid structure comprised substantially of the fused/bonded glass bubbles after the heating defines an inorganic skeleton of the porous structure of the present disclosure. Since the heating is at less than the devitrification temperature, the glass of the glass bubble 312 forming the inorganic skeleton remains substantially or fully amorphous after heating. In embodiments, the porous structure after the heating/firing, in terms of weight, comprises at least 80%, or at least 85%, or at least 90%, or at least 95%, or more of amorphous-phase glass.

In embodiments, the green structure 308 is heated using a unique firing process configured to enable a high amount (e.g., ≥50%) and/or a substantially high amount (e.g., 75%) of the glass bubbles 312 therein to remain closed (i.e., intact, and not breached) during the heating/firing. In embodiments, during the heating, the green structure 308 can be heated from ambient temperature to a first temperature(s) (e.g., fixed temperature and/or temperatures in a specified range) with a first dwell time, such as where the first temperature(s) is at least about 200° C. such as from about 300° C. to about 400° C., and where the first dwell time is at least 1 minute, such as from 1 hour to 10 hours, or from about 1 hour to about 8 hours, or from about 2 hours to about 6 hours, or from about 3 hours to about 5 hours.

In some such embodiments, after heating to the first temperature(s) with the first dwell time, the green structure 308 can be heated from the first temperature to a second temperature(s) with a second dwell time, such as where the second temperature(s) is greater than about 400° C., such as from about 400.5° C. to about 850° C., or from about 450° C. to about 800° C., or from about 475° C. to about 775° C. or from about 500° C. to about 700° C., or from about 570° C. to about 670° C., or from about 400.5° C. to about 675° C., and where the second dwell time is at least 1 minute, such as from 1 hour to 10 hours, or from about 1 hour to about 8 hours, or from about 2 hours to about 8 hours, or from about 2 hours to about 6 hours, or from about 4 hours to about 6 hours, or from about 3 hours to about 5 hours, or from about 3 hours to about 7 hours. In embodiments, the second temperature(s) is in a range of from at least the softening temperature of the glass of the glass bubbles 312 within the green structure 308 and to at most less than the devitrification temperature of the glass of the glass bubbles 312 within the green structure 308. As such, the second temperature(s) in embodiments can depend on the composition and/or attributes of the glass bubbles 312 within the green structure 308.

Following the heating, the green structure 308 can be cooled, such as to a temperature at least 100° C. less than the temperatures to which the green structure 308 was heated, such as to less than 100° C., such as less than 50° C. During the cooling, the adjoining glass bubbles 312 remain physically bonded to one another, such as directly bonded and/or indirectly bonded via the further inorganics, if present. In some such embodiments, the cooling includes dwelling at temperatures above room temperature (e.g., at an annealing point of the glass of the glass bubbles), but below the heating temperature. The dwelling can occur at incremental steps or can be in the form of gradual temperature declines within certain temperature ranges. Regardless of the cooling profile, the cooling can be configured to facilitate relaxing residual stresses via annealing while avoiding the formation of crystals in the materials of the glass bubbles 312.

In an exemplary embodiment, the rate(s) of heating is generally greater than the rate(s) of cooling. For example, in one embodiment, the heating to the first temperature(s) and/or the second temperature(s) can be at a ramp rate of at least 200° C./hour, such as from about 200° C./hour to about 400° C./hour. In such an embodiment, the cooling from the second temperature(s) can be at a ramp rate of less than 200° C./hour, such as from 50° C./hour to about 175° C./hour.

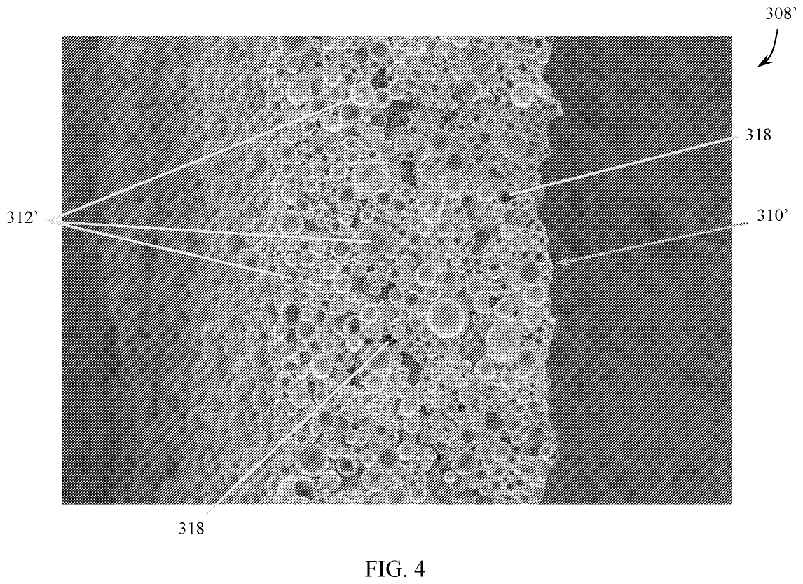

Referring now to FIG. 4, a scanning electron microscope (SEM) image of a porous structure 308′ that is related to the green structure 308 of FIG. 3 is shown. More specifically, the porous structure 308′ of FIG. 4 is formed after firing the green structure 308 according to the methods disclosed herein. Thus, the porous structure 308′ is not a “green” structure. Similar to the green structure 308, the fired porous structure 308′ has surface portions, including the surface portion 310′ shown in the foreground of the SEM image. The surface portions 310′ can form exterior walls or interior walls (or webs) of the fired porous structure 308′. The porous structure 308′ comprises a plurality of glass bubbles 312′ corresponding to the glass bubbles 312 of the green structure 308. The glass bubbles 312′ in the porous structure 308′ are fused and/or sintered to one another without or substantially without any organic constituents (e.g., binder) such that adjoining glass bubbles are physically bonded directly to one another.

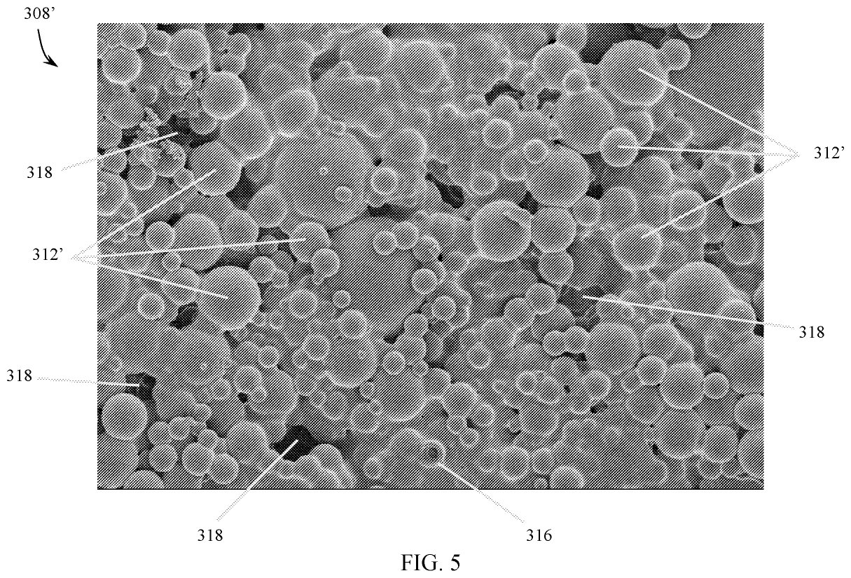

FIG. 5 is an enlarged portion of the SEM image of FIG. 4. The glass bubbles 312′ of the porous structure 308′ shown in FIG. 5 may be less spherical subsequent to the firing compared to the glass bubbles 312 of the green structure 308 of FIG. 3. Notwithstanding any modest changes in shape. FIGS. 4 and 5 illustrate that substantially all of the fused/sintered glass bubbles 312′ of the porous structure 308′ are closed (i.e., intact, and not breached) after firing the green structure 308 such that a respective shell of each glass bubble is continuous so as to define a sealed void therein. Such glass bubbles that are and/or remain closed after the firing can be referred to interchangeably as “closed glass bubbles.” In contrast, “open glass bubbles” can have shells that are fractured or otherwise discontinuous so as to define exposed voids therein (see 316 in FIG. 5). In embodiments, most (e.g., >50%) of the fused/sintered glass bubbles 312′ in the porous structure 308′ are closed glass bubbles. In embodiments, greater than 50%, or at least 65%, or at least 75%, or at least 85%, or at least 90%, or at least 95%, or at least 96%, or at least 97%, or at least 98%, or up to 100% of the glass bubbles 312′ in the porous structure 308′ are closed glass bubbles.

The percentage of closed glass bubbles can be estimated in embodiments. In one embodiment, an image of the porous structure (e.g., micrograph, SEM, etc.) can be configured to capture a minimum number of distinguishable glass bubbles within the view of the image (e.g., about 500, or 750, or 1000) such that the numbers of closed glass bubbles and total glass bubbles can be counted in the image. The percentage of closed glass bubbles is then estimated by dividing the number of individual closed glass bubbles by the total number of glass bubbles (closed and open/breached) in the view then multiplying by 100. In another embodiment, the open (breached) glass bubbles could be indicated by the volume during mercury porosimetry with the highest (or theoretical) pore volume obtained when all of the glass bubbles are open (breached). Accordingly, the close pore ratio can be estimated by the volume ratio: close pore volume ratio equals the theoretical pore volume (e.g., approximately 66-96 vol %) minus the open pore volume (via mercury porosimetry).

Referring still to FIG. 5, the shells or surfaces of the glass bubbles 312′ define interstices 318 throughout the porous structure 308′. In embodiments, some of the interstices 318 can be formed by voids left behind from burned-out binder (see binder 314 of FIG. 3). In embodiments, some of the interstices 318 and/or the open glass bubbles can be interconnected (defining tortuous pathways) and open to the surfaces of the porous structure 308′ so as to form an open porosity of the porous structure 308′. In embodiments, some of the interstices 318 do not open to the surfaces of the porous structure 308′ and, instead, are isolated within the porous structure 308′ and separated from the surfaces thereof. Such interstices 318 that are isolated within the porous structure 308′ can be referred to interchangeably as “closed interstices”. The sealed voids of the closed glass bubbles 312′ and the closed interstices 318 form a closed porosity of the porous structure 308′. Table 4 illustrates the beneficial open porosity achieved by the fired samples of Table 3 as well as attributes of the resulting pore sized distributions of the fired samples.

TABLE 4
Porosity and Pore Attributes of the Fired Samples of Table 3

| | Sample | | | |
|---|---|---|---|---|
| Description | 2- 1′ | 2- 2′ | 2-3′ | 2-4′ |
| Firing Temperature | 570 | 670 | 520 | 670 |
| (° C.) | | | | |
| Open Porosity (vol %) | 50.00% | 53.20% | 46.60% | 64.60% |
| Pore Size d10 (μm) | 0.004 | 0.2 | 0.005 | 0.004 |
| Pore Size d50 (μm) | 0.028 | 4 | 2.4 | 0.015 |
| Pore Size d90 (μm) | 9.5 | 9.5 | 6.6 | 14 |
| Pore Distribution | 339.14 | 2.33 | 2.75 | 933.07 |
| Breadth, db | | | | |
| Pore D-Factor, df | 0.86 | 0.95 | 1.00 | 0.73 |

As illustrated in Table 4, the porous structure 308′ can achieve an open porosity, as measured by mercury porosimetry, of at least 35%, or at least 40%, or at least 45%, or at least 50%, or at least 55%, or at least 60%, or at least 65%, or more up to about 70% in terms of volume. In embodiments, the closed porosity of the porous structure 308′ from the closed interstices and the sealed voids of the closed glass bubbles can be estimated with reference to the maximum open porosity of about 80% that Applicant has achieved when, directly contrary to the teachings herein, all or substantially all of the glass bubbles are breached during firing, such as described in International Application No. PCT/CN2020/083460, filed on Apr. 7, 2020 and published as WO 2021/203232 A1 on Oct. 14, 2021. The difference between the measured open porosity, such as the open porosity measured in Table 4, and the maximum open porosity provides an estimate of the closed porosity of the porous structure 308′. In such embodiments, the porous structure 308′ has a closed porosity of at least 10%, or at least 15%, or at least 20%, or at least 25%, or at least 30%, or at least 35%, or at least 40%, or more up to about 50% in terms of volume. In embodiments, the porous structure 308′ has a total porosity comprising a total of the open porosity and the closed porosity as indicated herein. In other embodiments, the closed porosity can be estimated with reference to the measured density. In yet further embodiments, the total porosity, including open porosity and closed porosity, can be measured using techniques such as small angle x-ray scattering (SAXS).

In embodiments, the porosity of the fired porous structure 308′ can be adjusted by use of different blends of the glass bubbles in the batch compositions. For example, the glass bubbles of a specific product designation from a supplier (i.e., glass bubble sample A, B, or C from Table 2) could be sieved to provide different groups of glass bubbles of the same glass bubble sample each having different particle size distributions with different size attributes. Thereafter, a batch composition can be formulated using different proportions (i.e., blends) of the different groups of the glass bubbles so as to adjust the resulting porosity of a fired porous structure formed from such a batch composition. Similarly, a batch composition can be formulated using glass bubbles of different glass bubble samples. For example, the batch composition of Sample 2-1 of Table 2, which includes glass bubbles of glass bubble sample B, can be modified to further include glass bubbles of glass bubble sample A and/or sample C so as to adjust the resulting porosity of a fired porous structure formed from such a batch composition.

In embodiments, the beneficial mixed (i.e., open and closed) porosity enables the porous structure 308′ to have very low density, such as less than 0.75 g/cm₃, or less than 0.7 g/cm₃, or less than 0.65 g/cm₃, or less than 0.6 g/cm₃, or less than 0.575 g/cm₃, or less than 0.55 g/cm₃, or less than 0.525 g/cm₃, or less than 0.52 g/cm₃, and at least about 0.4 g/cm₃.

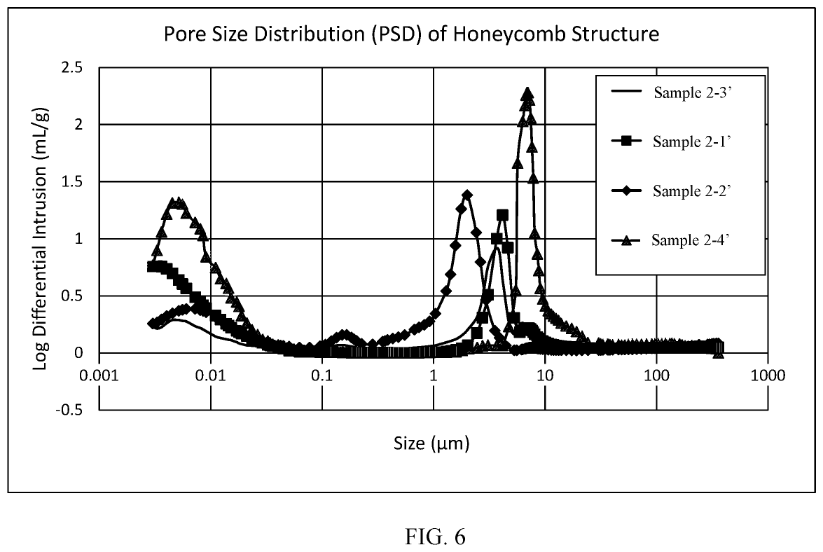

FIG. 6 is a graph showing the pore size distributions associated with open pores of the fired samples of Tables 3 and 4. In embodiments, the pores of the porous structure 308′ have a pore size distribution with a median pore size in a range of from about 0.008 μm to about 40 μm, or from about 0.01 μm to about 40 μm, or from about 0.05 μm to about 36 μm, or from about 0.09 μm to about 32 μm, or from about 0.13 μm to about 28 μm, or from about 0.17 μm to about 24 μm, or from about 0.21 μm to about 20 μm, or from about 0.01 μm to about 38 μm, or from about 0.01 μm to about 30 μm, or from about 0.01 μm to about 22 μm, or from about 0.03 μm to about 40 μm, or from about 0.11 μm to about 40 μm, or from about 0.19 μm to about 40 μm, and also comprising all sub-ranges and sub-values between these range endpoints. In embodiments, the mode of the pore size distribution is less than 15 μm, or less than 14 μm, or less than 12 μm, or less than 10 μm and at least 0.1 μm, or at least 0.5 μm, or at least 1 μm.

Referring again to FIGS. 1-4, the internal walls formed between the open channels of the porous structure 308′ may be particularly thin (T), such as less than 1 millimeters (mm) in thickness, such as less than 500 micrometers (μm), such as less than 100 μm, such as less than 50 μm, such as less than 10 μm, such as less than 5 μm in embodiments.

In contemplated embodiments, processes and technology disclosed herein are used as lightweight porous honeycomb structures for loading solid adsorbents, such as for CO₂ capture applications. Glass bubbles are selected with sufficient crush strength and small enough geometry to facilitate extrusion of honeycomb structures having at least 50 cells per square inch (cpsi), such as at least 100 cpsi, such as at least 200 cpsi, such as at least 300 cpsi, such as at least 400 cpsi, or even higher cpsi (e.g., 600, 700, 800, or 900 cpsi), and/or web thickness of at least about 2 mils (i.e. thousandths of an inch) and no more than about 15 mils, such as no more than about 11 mils, such as no more than about 10 mils, such as no more than about 8 mils, such as no more than about 7 mils, such as no more than about 6 mils, such as no more than about 5 mils, such as for example cell geometries at, at least as dense as, no denser than, or about 200/8 cpsi over web thickness in mils, 400/7, 400/6, 400/5, 400/4, 400/3, 400/2, 300/7, 300/6, 300/5, 300/4, 300/3, 300/2, 250/10, 200/7, 200/6, 200/5, 200/4, 100/8, 100/7, 100/6, 100/5, 50/8, 50/7, 50/6, etc.

At least some such embodiments have a cylindrical geometry, with a diameter of at least 4 inches, such as at least 6 inches, such as at least 8 inches, such as at least 12 inches, such as at least 24 inches, and/or no more than 64 inches, such as no more than 36 inches. Other such embodiments have a generally square, rectangular, or other polygonal geometry in cross-section, with sides of at least 4 inches, such as at least 6 inches, such as at least 8 inches, such as at least 12 inches, such as at least 24 inches, and/or no more than 64 inches, such as no more than 36 inches. Other contemplated embodiments have other sizes or shapes. Such geometries may facilitate low pressure drop.

The embodiments of the porous structures and assemblies and methods of forming the same provide many advantages over existing structures, assemblies, and methods. In embodiments, the firing temperature can be low (e.g., 500° C.) whereas existing structures are typically fired at higher temperatures (e.g., >800° C.). The unique firing process beneficially enables use of widely available glass bubbles in the market providing immediate cost advantage. When used in certain applications, such as CO₂ capture applications, the resulting mixed porosity of the fired porous structures with both relatively high open and closed porosities simplifies the firing process providing yet further cost savings. Furthermore, the fired porous structures formed according to the methods disclosed herein have very low density (e.g., ˜0.5 g/cm³) and similarly low heat capacity (e.g., ˜0.5 kJ/K), which is lower than many other ceramic honeycomb structures. Moreover, the fire porous structures formed according to the methods disclosed herein can enable on-wall/in wall coating for (solid) adsorbent such as PEI loading for CO₂ capture applications.

Construction and arrangements of the porous structures, assemblies, and structures as well as the methods of forming the same, as shown in the various embodiments, are illustrative only. Although only a few embodiments have been described in detail in this disclosure, many modifications are possible (e.g., variations in sizes, dimensions, structures, shapes, and proportions of the various elements, values of parameters, mounting arrangements, use of materials, colors, orientations) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes, and omissions may also be made in the design, operating conditions and arrangement of the various exemplary embodiments without departing from the scope of the present inventive technology.

In some modifications, different shaping processes (i.e., other than extrusion) are contemplated to form the green structures comprising the relatively high amounts of glass bubbles as disclosed herein. For example, the green structures can be formed using additive manufacturing techniques to build individual layers of the green structures using batch material comprising the relatively high amounts of glass bubbles distributed through a nozzle or similar orifice. In some modifications, the batch material can comprise material in addition to and/or in place of the further inorganics, such as polymer, carbon, ceramic, and/or metals. In such modifications, the relative proportion of glass bubbles, in terms of weight, in the batch material remains similar to the proportions disclosed herein.

1. A porous structure, comprising:
a plurality of glass bubbles,
wherein the glass bubbles are sintered to one another such that adjoining glass bubbles are physically bonded directly to one another,
wherein the glass bubbles have surfaces that define interstices throughout the porous structure, the interstices comprising closed interstices that do not open to surfaces of the porous structure,
wherein at least 50% of the glass bubbles are closed glass bubbles, each closed glass bubble defining a sealed void therein,
wherein the porous structure has at least 10% closed porosity in terms of volume, the closed porosity comprising the sealed voids and the closed interstices, and
wherein the porous structure has at least 40% open porosity in terms of volume.

2. The porous structure of claim 1, wherein, in terms of weight, the porous structure comprises mostly glass.

3. The porous structure of claim 1, wherein, in terms of weight, the porous structure comprises at least 90% of glass.

4. The porous structure of claim 1, wherein, in terms of weight, the porous structure comprises at least 85% of amorphous-phase glass.

5. (canceled)

6. The porous structure of claim 1, wherein from about 65% to about 100% of the glass bubbles are closed.

7. (canceled)

8. (canceled)

9. (canceled)

10. The porous structure of claim 1, wherein, in terms of weight, the porous structure comprises:
from about 0% to about 40% of further inorganics, and
at least about 55% of the glass bubbles.

11. (canceled)

12. The porous structure of claim 10, wherein, in terms of weight, the porous structure comprises at least about 95% of the glass bubbles.

13. (canceled)

14. (canceled)

15. The porous structure of claim 1, wherein, in terms of volume, the porous structure has from about 10% to about 40% closed porosity.

16. The porous structure of claim 1, wherein, in terms of volume, the porous structure has from about 40% to about 70% open porosity.

17. The porous structure of claim 1, wherein the porous structure has a cellular honeycomb geometry with a web thickness in a range of from about 2 to about 15 mils and a cell density in a range of from about 50 to about 400 cells per square inch.

18. The porous structure of claim 1, wherein the porous structure has a bulk density in a range of from about 0.4 g/cm³ to about 0.6 g/cm³.

19. The porous structure of claim 1, wherein the interstices comprise open interstices that open to the surfaces of the porous structure so as to define pores, the pores having a pore size distribution with a median pore size in a range of from about 0.008 μm to about 40 μm.

20. (canceled)

21. (canceled)

22. (canceled)

23. (canceled)

24. (canceled)

25. (canceled)

26. (canceled)

27. (canceled)

28. A method of making a porous structure, comprising:
bonding a plurality of glass bubbles to one another, wherein the glass bubbles have a median particle size in a range of from about 1 μm to about 100 μm, and wherein the plurality comprises at least 1000 of the glass bubbles; and
heating the glass bubbles, wherein substantially all of the glass bubbles are closed prior to the heating, substantially all adjoining glass bubbles sinter to one another during the heating, and at least 50% of the glass bubbles remain closed after the heating such that, in aggregate, the sintered, closed glass bubbles form the porous structure,
wherein each of the closed glass bubbles defines a sealed void therein, and wherein surfaces of the sintered glass bubbles define interstices throughout the porous structure, the interstices comprising closed interstices that do not open to surfaces of the porous structure, and
wherein the porous structure has at least 10% closed porosity in terms of volume, the closed porosity comprising the sealed voids and the closed interstices.

29. The method of claim 28, wherein from about 75% to about 100% of the glass bubbles remain closed after the heating.

30. (canceled)

31. The method of claim 28, wherein the heating comprises heating the glass bubbles to at least a softening temperature of amorphous glass of the glass bubbles.

32. The method of claim 28, further comprising, prior to the heating, extruding green material comprising the glass bubbles, an organic binder, and optionally further inorganics, wherein substantially all of the glass bubbles remain closed after the extruding, wherein:
the green material further comprises a liquids portion comprising one or more of oil and water,
the glass bubbles, the organic binder, and the optional further inorganics define a solids portion of the green material, and
the solids portion is greater than the liquids portion in terms of weight.

33. (canceled)

34. (canceled)

35. The method of claim 32, wherein one or more of:
in terms of weight, the solids portion is at least 10% greater than the liquids portion of the green material,
in terms of weight, the green material comprises at least 55% of the solids portion, and
a ratio of a weight of the solids portion to a weight of the liquids portion is in a range of from about 1.2 to about 1.7.

36. (canceled)

37. (canceled)

38. The method of claim 32, wherein, in terms of weight, the green material comprises:
at least about 30% of the glass bubbles,
from about 3% to about 10% of the organic binder,
from about 0% to about 25% of the optional further inorganics, and
from about 35% to about 45% of the liquids portion.

39. (canceled)

40. The method of claim 32, wherein the further inorganics comprise one or more of clay, talc, sepiolite, bentonite, CaCO₃, Na₂CO₃, NaHCO₃, ZrO₂, Al₂O₂, MgO, and SiO₂.

41. The method of claim 28, wherein, during the heating, the glass bubbles are heated to a first temperature range for a first dwell time, and then heated to a second temperature range for a second dwell time,
wherein the first temperature range is from about 200° C. to about 400° C.;
wherein the first dwell time is in a range from about 2 hours to about 6 hours, and
wherein, during the heating, the second temperature range is above 400° C. and below a devitrification temperature of amorphous glass of the glass bubbles, and wherein the second dwell time is in a range from about 3 hours to 7 hours.

42. (canceled)

43. (canceled)

44. (canceled)

45. (canceled)
